(19) United States
(12) Patent Application Publication
(10) Pub. No.: US 2016/0311994 A1
(43) Pub. Date: Oct. 27, 2016

(54) ANISOTROPIC POLYCARBONATE FOAM

(71) Applicant: SABIC GLOBAL TECHNOLOGIES B.V., Bergen op Zoom (NL)

(72) Inventors: Martin Van Es, Geleen (NL); Mark Berix, Bergen op Zoom (NL); John Krist, Geleen (NL)

(21) Appl. No.: 15/102,618

(22) PCT Filed: Jan. 16, 2015
(86) PCT No.: PCT/IB2015/050341

§ 371 Date: Jun. 8, 2016

Related U.S. Application Data
(60) Provisional application No. 61/928,538, filed on Jan. 17, 2014.

(51) Int. Cl. C08J 9/14; B29C 44/34

(52) U.S. Cl. CPC C08J 9/141; B29C 44/352; B29C 44/3469; B29C 44/3415; B29C 44/3449; C08J 2369/00; C08J 2201/03; C08J 2203/14; C08J 2205/052; B29K 2069/00

(57) ABSTRACT

An anisotropic polycarbonate foam is disclosed. The polycarbonate foam has a low open cell content, and has improved mechanical properties as specified herein. A process for making an anisotropic polycarbonate foam, can comprise: melting a polycarbonate in an extruder to obtain a molten formulation; injecting a blowing agent into the molten formulation; mixing the molten formulation to obtain a single phase mixture; and extruding the single phase mixture through a die to obtain the anisotropic polycarbonate foam.

### BACKGROUND

The present disclosure relates to foamed polycarbonate materials having specified properties. These foams are useful in applications as a core material having a very high strength-to-weight ratio. Also disclosed are processes for making the anisotropic foams.

Anisotropic foams like polyurethane (PU) foams, polyethylene terephthalate (PET) foams, and balsa wood are used as core materials in composite materials. The mechanical properties of these materials vary widely. For example, Balsalite BL 6.5 R balsa wood (available from Nida Core, Saint Lucie, Fla.) has a density of 108 kg/m³, a compression strength of 6.76 MPa, a compression modulus of 2241 MPa, a shear strength of 1.85 MPa, a shear modulus of 107.6 MPa, and a tensile strength of 6.89 MPa. NidaFoam PET 100 polyethylene terephthalate foam (available from Nida Core, Saint Lucie, Fla.) has a density of 100 kg/m³, a compression strength of 1.86 MPa, a compression modulus of 84 MPa, a shear strength of 1.19 MPa, a shear modulus of 27.9 MPa, a tensile strength of 2.1 MPa, a tensile modulus of 107 MPa, and a closed cell rate of less than 90%. Polyurethane foam has a density of 96 kg/m³, a compression strength of 0.9 MPa, a compression modulus of 21 MPa, a shear strength of 0.55 MPa, a shear modulus of 5.5 MPa, a tensile strength of 0.66 MPa, a tensile modulus of 16.5 MPa, and a closed cell rate of less than 95%.

The mechanical properties of the balsa wood are better than the PET foam or the PU foam. However, balsa wood is a natural product and is inconsistent in quality, and is also sensitive to rot. In addition, balsa wood cannot be thermoformed. Another disadvantage of balsa wood is that during manufacturing of a composite material, the wood will take up (i.e. absorb) a large quantity of resin, i.e. has a large open cell content. PET foams take up less resin, but still have an open cell content that is usually larger than 10%. PET foams also require a specialized coalescent strand die to be foamed and require post drawing to obtain desired anisotropic properties. PU foams with an open cell content of about 5% have the lowest resin uptake. However, PU foams are chemically foamed. There remains a need and desire for a foam which can be used as a core material and has good mechanical properties.

### BRIEF DESCRIPTION

The present disclosure relates to anisotropic polycarbonate foams that have specified properties. These foams can be used as core materials for a composite, and are useful in applications requiring a high strength-to-weight ratio.

Disclosed in various embodiments are anisotropic polycarbonate foams, having: a density of about 30 kg/m³ to about 1200 kg/m³; and a weight average molecular weight of about 12,000 to about 50,000 daltons, using gel permeation chromatography with polystyrene standards.

In more specific embodiments, the anisotropic polycarbonate foam also has an open cell content of 20% or less, or an open cell content of 5% or less.

The foam can in narrower embodiments have a density of about 80 kg/m³ to about 350 kg/m³. In other embodiments, the foam can have a weight average molecular weight of about 25,000 to about 50,000 daltons.

The polycarbonate can be derived from bisphenol-A. The foam may use a branched polycarbonate, or can use a linear polycarbonate.

Also disclosed herein are processes for making an anisotropic polycarbonate foam, comprising: melting a polycarbonate in an extruder to obtain a molten formulation; injecting a blowing agent into the molten formulation; mixing the molten formulation to obtain a single phase mixture; and extruding the single phase mixture through a die to obtain the anisotropic polycarbonate foam.

The blowing agent can be isobutane.

In particular embodiments, the die has a length of about 1 mm to about 2 mm, and has a diameter of about 3 mm to about 10 mm.

The molten formulation sometimes includes a nucleating agent, such as talcum or fused silica.

The die can be maintained at a die temperature of about 160° C. to about 180° C.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a first scanning electron microscope (SEM) micrograph of a branched polycarbonate foam in the cross-flow direction at 200× magnification.

FIG. 2 is a second scanning electron microscope (SEM) micrograph of the same branched polycarbonate foam in the cross-flow direction at 200× magnification (different location).

FIG. 3 is a third scanning electron microscope (SEM) micrograph of the same branched polycarbonate foam in the cross-flow direction at 200× magnification (different location).

FIG. 4 is a fourth scanning electron microscope (SEM) micrograph of the same branched polycarbonate foam in the cross-flow direction at 200× magnification (different location).

FIG. 5 is a scanning electron microscope (SEM) micrograph of the same branched polycarbonate foam in the cross-flow direction at 300× magnification.

FIG. 6 is a scanning electron microscope (SEM) micrograph of the same branched polycarbonate foam in the in-flow direction at 40× magnification.

FIG. 7 is a scanning electron microscope (SEM) micrograph of the same branched polycarbonate foam in the in-flow direction at 50× magnification.

FIG. 8 is a scanning electron microscope (SEM) micrograph of the same branched polycarbonate foam in the in-flow direction at 50× magnification (different location).

FIG. 9 is a scanning electron microscope (SEM) micrograph of the same branched polycarbonate foam in the in-flow direction at 75× magnification (different location).

FIG. 10 is a scanning electron microscope (SEM) micrograph of the same branched polycarbonate foam in the in-flow direction at 103× magnification.

FIG. 11 is a graph showing the stress (in MegaPascals (MPa)) versus strain (%) relationship for a linear polycarbonate that was used to make an anisotropic foam.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

The singular forms “a,” “an,” and “the” include plural referents unless the context clearly dictates otherwise.

As used in the specification and in the claims, the term “comprising” may include the embodiments “consisting of” and “consisting essentially of.”

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.”

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, the aldehyde group —CHO is attached through the carbon of the carbonyl group.

The term “aliphatic” refers to a linear or branched array of atoms that is not cyclic and has a valence of at least one. Aliphatic groups are defined to comprise at least one carbon atom. The array of atoms may include heteroatoms such as nitrogen, sulfur, silicon, selenium and oxygen in the backbone or may be composed exclusively of carbon and hydrogen. Aliphatic groups may be substituted or unsubstituted. Exemplary aliphatic groups include, but are not limited to, methyl, ethyl, isopropyl, isobutyl, hydroxymethyl (—CH₂OH), mercaptomethyl (—CH₂SH), methoxy, methoxycarbonyl (CH₃OCO—), nitromethyl (—CH₂NO₂), and thiocarbonyl.

The term “alkyl” refers to a linear or branched array of atoms that is composed exclusively of carbon and hydrogen. The array of atoms may include single bonds, double bonds, or triple bonds (typically referred to as alkane, alkene, or alkyne). Alkyl groups may be substituted (i.e. one or more hydrogen atoms is replaced) or unsubstituted. Exemplary alkyl groups include, but are not limited to, methyl, ethyl, and isopropyl. It should be noted that alkyl is a subset of aliphatic.

The term “aromatic” refers to an array of atoms having a valence of at least one and comprising at least one aromatic group. The array of atoms may include heteroatoms such as nitrogen, sulfur, selenium, silicon and oxygen, or may be composed exclusively of carbon and hydrogen. Aromatic groups are not substituted. Exemplary aromatic groups include, but are not limited to, phenyl, pyridyl, furanyl, thienyl, naphthyl and biphenyl.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms). It should be noted that aryl is a subset of aromatic.

The term “cycloaliphatic” refers to an array of atoms which is cyclic but which is not aromatic. The cycloaliphatic group may include heteroatoms such as nitrogen, sulfur, selenium, silicon and oxygen in the ring, or may be composed exclusively of carbon and hydrogen. A cycloaliphatic group may comprise one or more noncyclic components. For example, a cyclohexylmethyl group (C₆H₁₁CH₂—) is a cycloaliphatic functionality, which comprises a cyclohexyl ring (the array of atoms which is cyclic but which is not aromatic) and a methylene group (the noncyclic component). Cycloaliphatic groups may be substituted or unsubstituted. Exemplary cycloaliphatic groups include, but are not limited to, cyclopropyl, cyclobutyl, 1,1,4,4-tetramethylcyclobutyl, piperidinyl, and 2,2,6,6-tetramethylpiperydinyl.

The term “cycloalkyl” refers to an array of atoms which is cyclic but is not aromatic, and which is composed exclusively of carbon and hydrogen. Cycloalkyl groups may be substituted or unsubstituted. It should be noted that cycloalkyl is a subset of cycloaliphatic.

The present disclosure relates to anisotropic polycarbonate foams which are useful in many different applications. For example, they can be used as the structural core material of a wind turbine blade; the core material in a composite or artificial wood; or structural components or insulation in vehicles such as boats, trains, cars, and airplanes. In some composite materials, the core material is sandwiched between two other layers or skins. In other composites, only one layer or skin is applied to a surface of the core material.

The term “anisotropic:” refers to the fact that certain properties of the polycarbonate foam differ depending on the axis along which the property is measured. For purposes of this disclosure, properties are measured against two axes (in-flow and cross-flow) which are perpendicular to each other.

The term “foam” refers to the structure formed when a gas is blown through the polycarbonate as it solidifies. It should be recognized though that this “foam” structure can also be formed through other methods, such as solid state foaming, blending two components and then extracting one component to create a foam of the other component, or by sol-gel technology. Foaming results in pockets, or cells, being formed throughout the polycarbonate. One property of a foam is its open/closed cell content. A closed cell is a discrete pocket which is completely surrounded by the polycarbonate. An open cell is a pocket that has at least one opening which eventually connects to the surface of the polycarbonate. Open cells negatively affect the mechanical properties of the foam, and also lead to uptake of large amounts of polymer resin during the production of a composite structure.

The anisotropic polycarbonate foams of the present disclosure have improved mechanical properties, and at the same time have a low open cell content. The processes for making these polycarbonate foams is simpler compared to, for example, PET foams. It is not necessary to draw the foam to obtain the desired anisotropic properties, and complicated die designs are not required to produce the foam.

As used herein, the terms “polycarbonate” and “polycarbonate polymer” mean a polymer having repeating structural carbonate units of the formula (1):

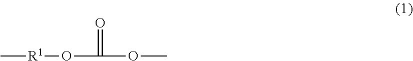

in which at least about 60 percent of the total number of R¹ groups are aromatic organic radicals and the balance thereof are aliphatic, alicyclic, or aromatic radicals. An ester unit (—COO—) is not considered a carbonate unit, and a carbonate unit is not considered an ester unit. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, wherein R¹ is as defined above. Dihydroxy compounds suitable in an interfacial reaction include the dihydroxy compounds of formula (A) as well as dihydroxy compounds of formula (3)

HO-A¹-Y¹-A²-OH (3)

wherein Y¹, A¹ and A² are as described above. Also included are bisphenol compounds of general formula (4):

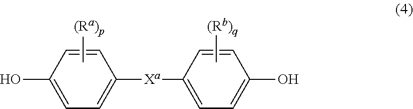

wherein R^{a} and R^{b} each represent a halogen atom or a monovalent hydrocarbon group and may be the same or different; p and q are each independently integers of 0 to 4; and X^{a} represents one of the groups of formula (5):

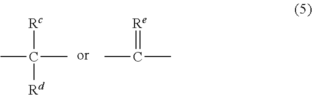

wherein R^{c} and R^{d} each independently represent a hydrogen atom or a monovalent linear or cyclic hydrocarbon group and R^{e} is a divalent hydrocarbon group.

Specific examples of the types of bisphenol compounds that may be represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol-A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, and 2-phenyl-3,3-bis(4-hydroxyphenyl) phthalimidine (“PPPBP”). Combinations comprising at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 wt % to about 2.0 wt %.

“Polycarbonate” and “polycarbonate polymer” as used herein further includes blends of polycarbonates with other copolymers comprising carbonate chain units. An exemplary copolymer is a polyester carbonate, also known as a copolyester-polycarbonate. Such copolymers further contain, in addition to recurring carbonate chain units of the formula (1), repeating units of formula (6):

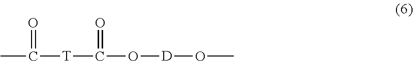

wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T is a divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical. In other embodiments, dicarboxylic acids that contain a C4-C36 alkylene radical may be used to form copolymers of formula (6). Examples of such alkylene radicals include adipic acid, sebacic acid, or dodecanoic acid.

In one embodiment, D is a C₂₋₆ alkylene radical. In another embodiment, D is derived from an aromatic dihydroxy compound of formula (7):

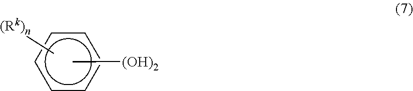

wherein each R^{k} is independently a C₁₋₁₀ hydrocarbon group, and n is 0 to 4. The halogen is usually bromine. Examples of compounds that may be represented by the formula (7) include resorcinol, substituted resorcinol compounds such as 5-methyl resorcinol, 5-phenyl resorcinol, 5-cumyl resorcinol, or the like; catechol; hydroquinone; substituted hydroquinones such as 2-methyl hydroquinone, 2-t-butyl hydroquinone, 2-phenyl hydroquinone, 2-cumyl hydroquinone, 2,3,5,6-tetramethyl hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof.

In other embodiments, poly(alkylene terephthalates) may be used. Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexane-dimethanol-1,4-cyclohexanedicarboxylate) (PCCD), having recurring units of formula (8):

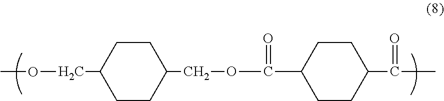

wherein, as described using formula (6), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

In specific embodiments of the present disclosure, the polycarbonate polymer (A) is derived from a dihydroxy compound having the structure of Formula (I):

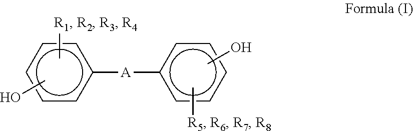

wherein R₁ through R₈ are each independently selected from hydrogen, nitro, cyano, C₁-C ₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl) propane (i.e. bisphenol-A or BPA). Other illustrative compounds of Formula (I) include: 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 1,1-bis(4-hydroxyphenyl)cyclohexane; 4,4′dihydroxy-1,1-biphenyl; 4,4′-dihydroxy-3,3′-dimethyl-1,1-biphenyl; 4,4′-dihydroxy-3,3′-dioctyl-1,1-biphenyl; 4,4′-dihydroxydiphenylether; 4,4′-dihydroxydiphenylthioether; and 1,3-bis(2-(4-hydroxyphenyl)-2-propyl)benzene.

In more specific embodiments, the polycarbonate polymer used to make the polycarbonate foam is a bisphenol-A homopolymer. The polycarbonate polymer may have a weight average molecular weight (Mw) of from about 12,000 to about 50,000 daltons, measured by gel permeation chromatography relative to polystyrene standards, including a range of from about 25,000 to about 50,000 daltons. Unless specifically specified otherwise, the weight average molecular weight (Mw) disclosed herein is in daltons and is determined by gel permeation chromatography relative to polystyrene standards. The polycarbonate polymer can be a linear or branched polycarbonate.

The polycarbonates can be manufactured by processes known in the art, such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury™ mixer, twin screw extruder, or the like to form a uniform dispersion. Volatile monohydric phenol is removed from the molten reactants by distillation and the polymer is isolated as a molten residue. After polymerization, the polycarbonate is usually pelletized. The pellets are then processed to obtain the anisotropic polycarbonate foam.

The anisotropic polycarbonate foam can be produced using an extruder. Polycarbonate is loaded into the extruder, for example by dosing and conveying pellets, granules, or powder. A nucleating agent may also be added. The polycarbonate is then melted and plasticized in the extruder to obtain a molten formulation. A blowing agent is then injected into the molten formulation. This can be done, for example, by injection of a pressurized gas through the barrel of the extruder. The molten formulation is then mixed homogeneously to obtain a single phase mixture. The single phase mixture is then extruded through a nozzle having a die for shaping the extruded product. Due to the pressure drop through the nozzle, thermodynamic instability in the single phase mixtures provokes and controls the nucleation, growth, and coalescence of pores to create the foam. The material can then be shaped and cooled to the desired form upon return to atmospheric pressure. For example, in one construction, the extruder is a double screw extruder followed by a static mixer for cooling the molten formulation after extrusion through the die. As desired, other devices may be added to the end of the extruder for desired processing of the polycarbonate foam.

Examples of physical blowing agents that can be used to produce the foam include chlorofluorocarbons, hydrochlorocarbons, hydrofluorcarbons, hydrocarbons and atmospheric gases such as isobutane, CO₂, pentane, butane and/or nitrogen. Preferred physical blowing agents are isobutane and CO₂. The blowing agent may be from about 0.3 wt % to about 20 wt % of the polycarbonate foam. In more specific embodiments, the blowing agent is about 0.3 wt % to about 10 wt %, 1 wt % to about 13 wt %, or about 2 wt % to about 10 wt %, of the polycarbonate foam.

Nucleating agents include talcum, fused silica, or a mixture of sodium bicarbonate and citric acid. Other suitable nucleating agents include an amide, an amine and/or an ester of a saturated or unsaturated aliphatic (C₁₀-C₃₄) carboxylic acid. Examples of suitable amides include fatty acid (bis)amides and alkylenediyl-bis-alkanamides, preferably (C₂-C₃₂) alkylenediyl-bis-(C₂-C₃₂) alkanamides, such as for example ethylene bistearamide (EBS), butylene bistearamide, hexamethylene bistearamide and/or ethylene bisbehenamide. Suitable amines include or instance (C₂-C₁₈) alkylene diamines such as for example ethylene biscaproamine and hexamethylene biscaproamine. Preferred esters of a saturated or unsaturated aliphatic (C₁₀-C₃₄) carboxylic acid are the esters of an aliphatic (C₁₆-C₂₄) carboxylic acid. Generally, the nucleating agent is present in an amount of about 0.1 wt % to about 4.0 wt % of the polycarbonate foam, including from about 0.5 wt % to 1.0 wt %.

The nozzle of the extruder is temperature controlled and used to generate a high and rapid pressure drop. Both the magnitude of the pressure drop and the pressure drop rate are determined by the viscosity of the polymer, the throughput of the polymer through the die, and the die dimensions. In general, small diameter dies are used to generate high pressure drops, while short dies are used to generate high pressure drop rates. The magnitude of the pressure drop may vary from about 3 MPa to 50 MPa, while the pressure drop rate may vary from 0.01 to 100 gigapascals per second (GPa/sec). The die itself can have a length of about 1 millimeter (mm) to about 2 mm, and have a diameter of about 3 mm to about 10 mm, though this depends on the molar mass of the polymer and on the throughput of the polymer through the die. The temperature of the polymer exiting the die can be from about 150° C. to about 200° C., including about 160° C. to about 180° C., or in more specific embodiments about 172° C. to about 175° C.

The resulting anisotropic polycarbonate foam has a desirable combination of density, open cell content, and molecular weight. The foam may have a density of about 30 kilogram per cubic meter (kg/m³) to about 1200 kg/m³, including about 80 kg/m³ to about 350 kg/m³, about 80 kg/m³ to about 120 kg/m³, or from about 100 kg/m³ to about 350 kg/m³. The foam may have an open cell content of 20% or less, including 10% or less and 5% or less. The foam may have a weight average molecular weight (Mw) of about 12,000 to about 50,000, including from about 25,000 to about 50,000. All combinations of the ranges of these three properties are specifically contemplated. In particularly desirable embodiments, the polycarbonate is a linear polycarbonate having an Mw of at least 35,000 g/mol. Particular applications for this foam include use in windmill blades.

In additional embodiments, the foam has a density of about 30 kg/m³ to about 1200 kg/m³; an open cell content of 20% or less; and an Mw of about 12,000 to about 50,000. In some embodiments, the foam has a density of about 80 kg/m³ to about 350 kg/m³; an open cell content of 20% or less; and an Mw of about 12,000 to about 50,000. In other embodiments, the foam has a density of about 80 kg/m³ to about 120 kg/m³; an open cell content of 20% or less; and an Mw of about 12,000 to about 50,000. In more embodiments, the foam has a density of about 100 kg/m³ to about 350 kg/m³; an open cell content of 20% or less; and an Mw of about 12,000 to about 50,000. In other embodiments, the foam has a density of about 30 kg/m³ to about 1200 kg/m³; an open cell content of 20% or less; and an Mw of about 25,000 to about 50,000. In some embodiments, the foam has a density of about 80 kg/m³ to about 350 kg/m³; an open cell content of 20% or less; and an Mw of about 25,000 to about 50,000. In other embodiments, the foam has a density of about 80 kg/m³ to about 120 kg/m³; an open cell content of 20% or less; and an Mw of about 25,000 to about 50,000. In more embodiments, the foam has a density of about 100 kg/m³ to about 350 kg/m³; an open cell content of 20% or less; and an Mw of about 25,000 to about 50,000. Again, the polycarbonate can be a linear or a branched polycarbonate.

In additional embodiments, the foam has a density of about 30 kg/m³ to about 1200 kg/m³; an open cell content of 10% or less; and an Mw of about 12,000 to about 50,000. In some embodiments, the foam has a density of about 80 kg/m³ to about 350 kg/m³; an open cell content of 10% or less; and an Mw of about 12,000 to about 50,000. In other embodiments, the foam has a density of about 80 kg/m³ to about 120 kg/m³; an open cell content of 10% or less; and an Mw of about 12,000 to about 50,000. In more embodiments, the foam has a density of about 100 kg/m³ to about 350 kg/m³; an open cell content of 10% or less; and an Mw of about 12,000 to about 50,000. In other embodiments, the foam has a density of about 30 kg/m³ to about 1200 kg/m³; an open cell content of 10% or less; and an Mw of about 25,000 to about 50,000. In some embodiments, the foam has a density of about 80 kg/m³ to about 350 kg/m³; an open cell content of 10% or less; and an Mw of about 25,000 to about 50,000. In other embodiments, the foam has a density of about 80 kg/m³ to about 120 kg/m³; an open cell content of 10% or less; and an Mw of about 25,000 to about 50,000. In more embodiments, the foam has a density of about 100 kg/m³ to about 350 kg/m³; an open cell content of 10% or less; and an Mw of about 25,000 to about 50,000. Again, the polycarbonate can be a linear or a branched polycarbonate.

In additional embodiments, the foam has a density of about 30 kg/m³ to about 1200 kg/m³; an open cell content of 5% or less; and an Mw of about 12,000 to about 50,000. In some embodiments, the foam has a density of about 80 kg/m³ to about 350 kg/m³; an open cell content of 5% or less; and an Mw of about 12,000 to about 50,000. In other embodiments, the foam has a density of about 80 kg/m³ to about 120 kg/m³; an open cell content of 5% or less; and an Mw of about 12,000 to about 50,000. In more embodiments, the foam has a density of about 100 kg/m³ to about 350 kg/m³; an open cell content of 5% or less; and an Mw of about 12,000 to about 50,000. In other embodiments, the foam has a density of about 30 kg/m³ to about 1200 kg/m³; an open cell content of 5% or less; and an Mw of about 25,000 to about 50,000. In some embodiments, the foam has a density of about 80 kg/m³ to about 350 kg/m³; an open cell content of 5% or less; and an Mw of about 25,000 to about 50,000. In other embodiments, the foam has a density of about 80 kg/m³ to about 120 kg/m³; an open cell content of 5% or less; and an Mw of about 25,000 to about 50,000. In more embodiments, the foam has a density of about 100 kg/m³ to about 350 kg/m³; an open cell content of 5% or less; and an Mw of about 25,000 to about 50,000. Again, the polycarbonate can be a linear or a branched polycarbonate.

The following examples are provided to illustrate the polycarbonate foams and processes of the present disclosure. The examples are merely illustrative and are not intended to limit the disclosure to the materials, conditions, or process parameters set forth therein.

### EXAMPLES

### Example 1

The density of the polycarbonate foams formed herein was obtained as follows. The sample rods are first weighed in air (mass in grams). They are then immersed within water and the water level displacement is measured in a graduated cylinder. From this data, the density can be obtained.

Scanning electron microscopy (SEM) was performed using an XL30 LaB6 microscope (available from FEI) operated at 15 kV and SE mode.

A branched polycarbonate foam was produced at an extruder rate of 5 kg/hr, using 5 wt % isobutane for the blowing agent, and a die of 5 mm with a die temperature of 170° C. No nucleating agent was used. The resulting sample had a Mw of 33,700 g/mol as measured by gel permeation chromatography relative to polystyrene standards, a rod diameter of 15-16 mm, and a density of 85 kg/m³. This foam was made from a composition containing 99.77 wt % of the polycarbonate (branched using 1,1,1-tris-(p-hydroxyphenyl)ethane), 0.06 wt % of tris(di-t-butylphenyl) phosphite, and 0.17 wt % of a color package used to obtain a clear color.

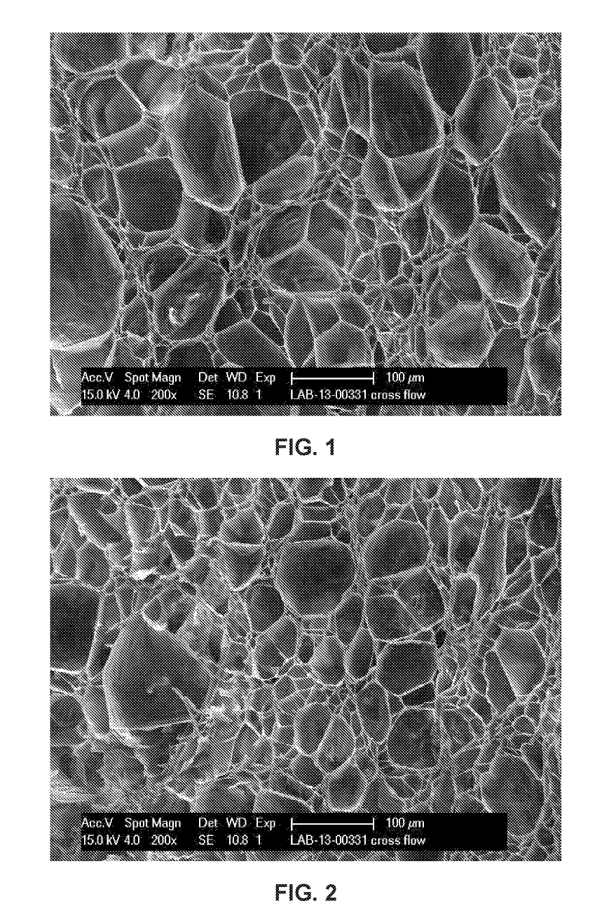

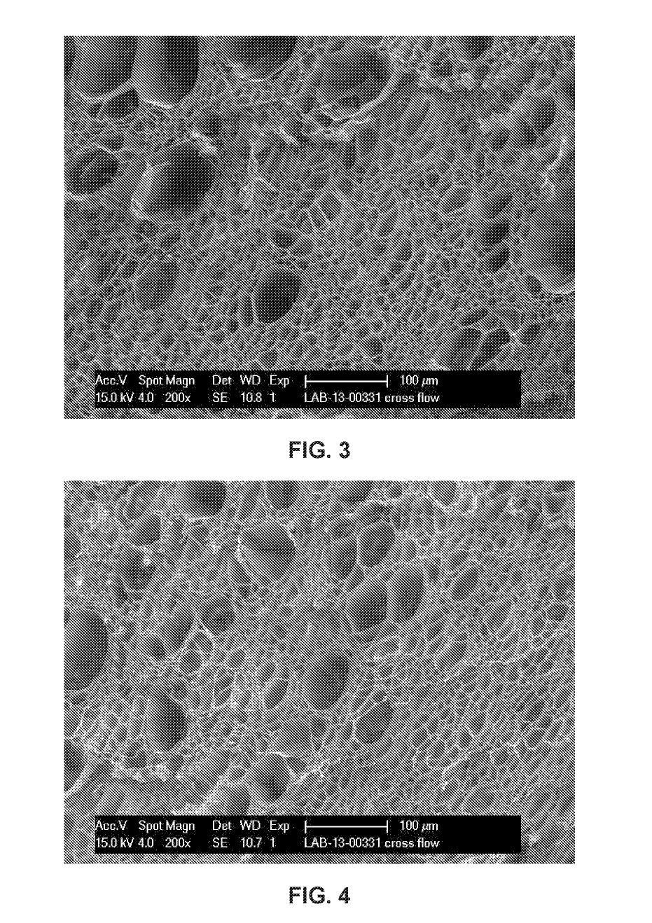

FIGS. 1-5 show the cell size distribution perpendicular to the processing direction (i.e. the cross-flow direction). FIGS. 1-4 are at 200× magnification, while FIG. 5 is at 300×. Again, no nucleating agent was used, resulting in a broad cell size range. Using a nucleating agent should result in a more homogeneous morphology.

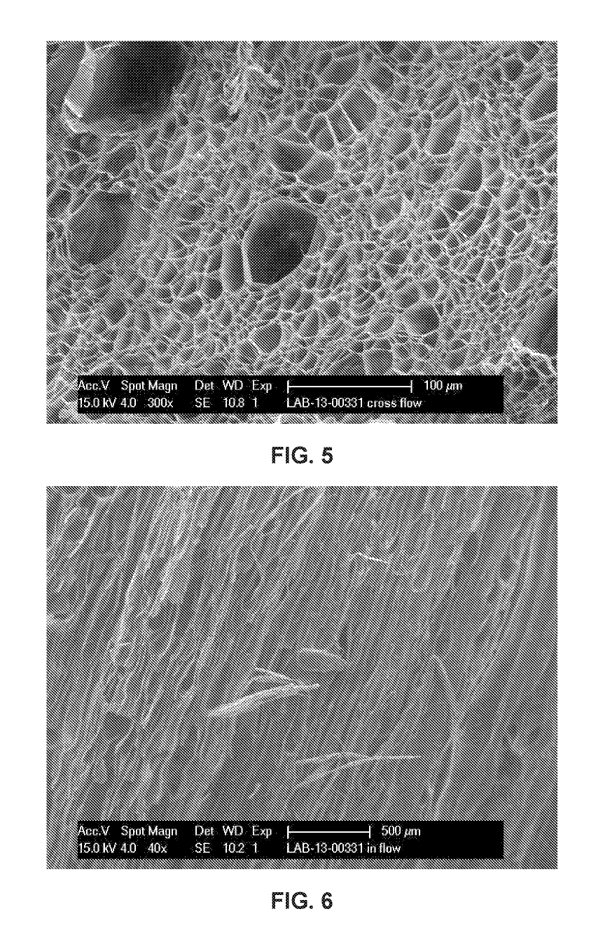

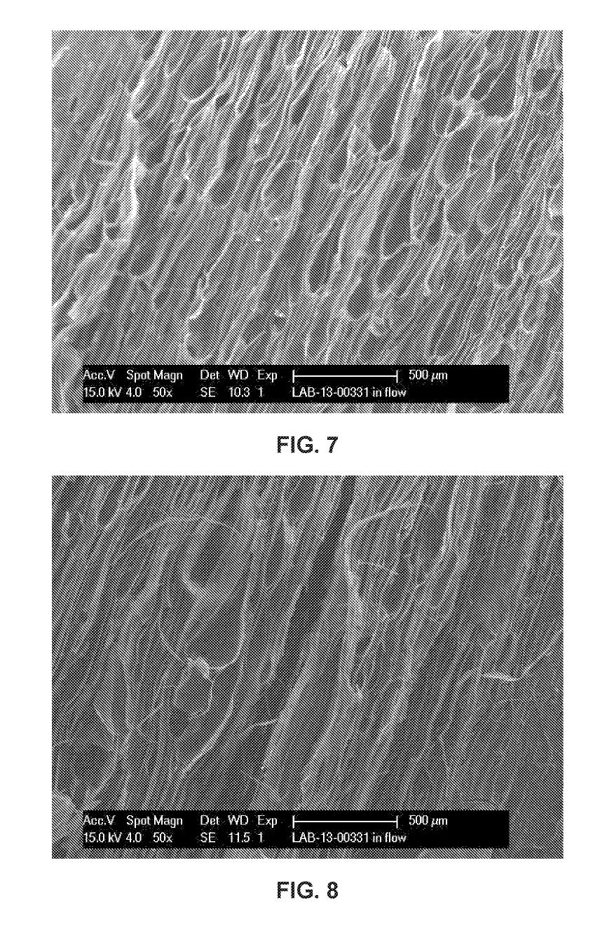

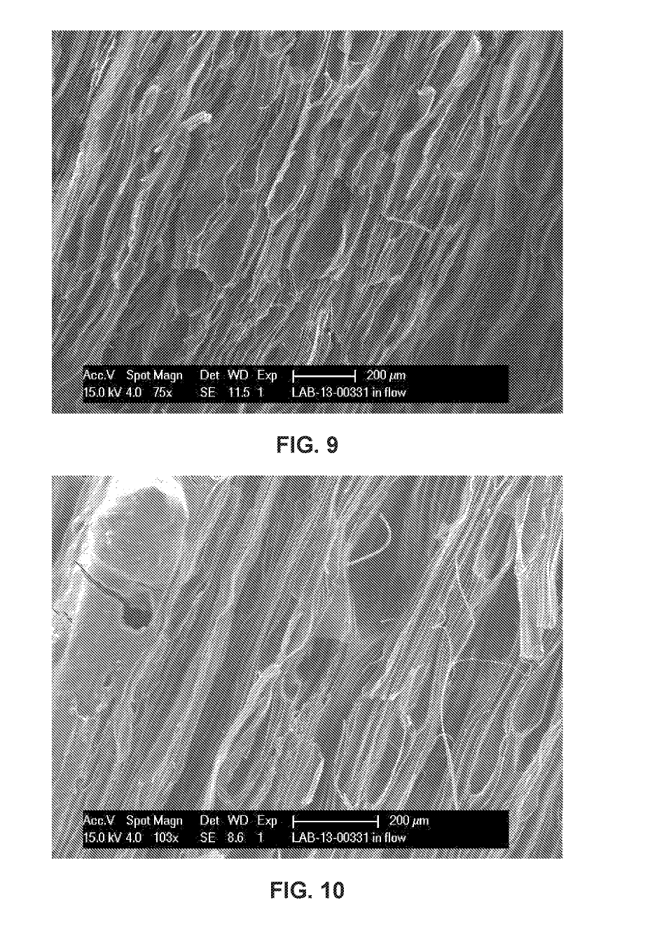

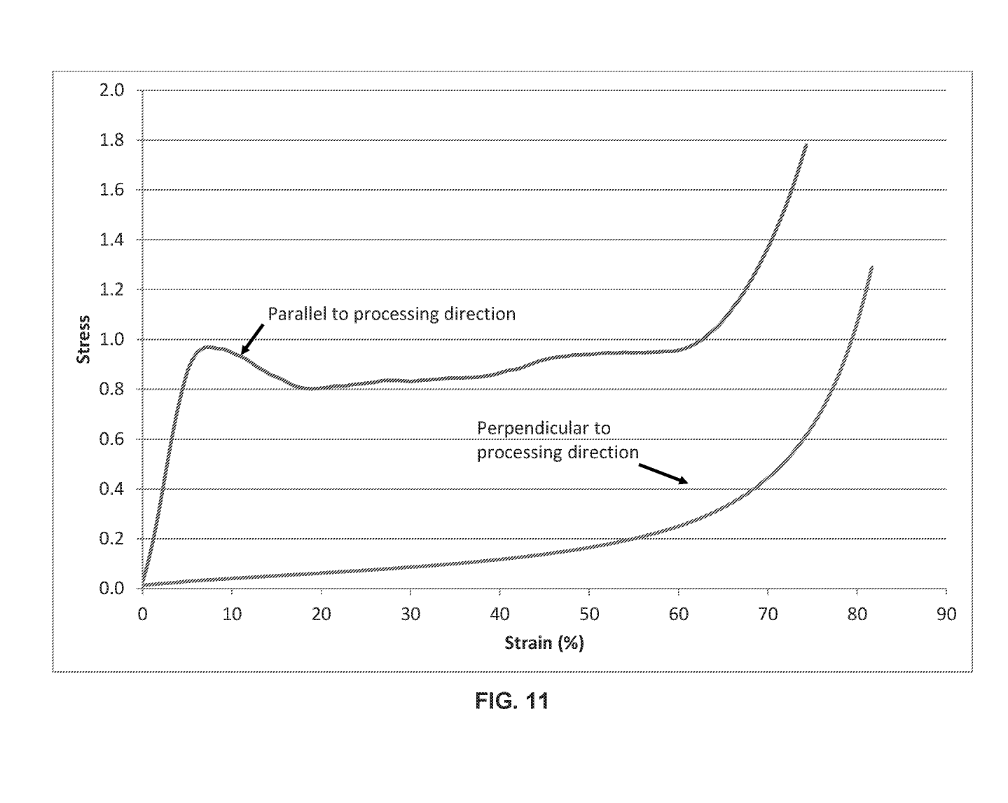

FIGS. 6-10 show the cell size distribution in the processing direction (i.e. the in-flow direction). FIG. 6 is at 40× magnification, FIG. 7 and FIG. 8 are at 50× magnification, FIG. 9 is at 75×, and FIG. 10 is at 103×. The formed channels can be seen in these pictures.

The above results demonstrate that the polycarbonate foam morphology is similar to balsa wood.

### Example 2

A polycarbonate composition was used to make a polycarbonate foam whose properties were tested. The polycarbonate composition included 99.47 wt % of a linear bisphenol-A homopolymer using phenol endcap, 0.35 wt % of demineralized water, 0.05 wt % of tris(di-t-butylphenyl) phosphite, and 0.13 wt % of a color package used to obtain a clear color. The bisphenol-A homopolymer had a target Mw of 35,000 g/mol as measured by gel permeation chromatography relative to polystyrene standards, and a target intrinsic viscosity (IV) of 64.5 dL/g.

The polycarbonate foam was tested using a tensile tester to mechanically compress the foam parallel to and perpendicular to the processing direction. The results are shown in FIG. 11. This graph shows that the foam was anisotropic, i.e. had different properties in different directions. Like balsa wood, the anisotropic polycarbonate is stronger in the processing direction than the perpendicular direction.

Set forth below are some embodiments of the foam and method disclosed herein.

Embodiment 1: An anisotropic polycarbonate foam, having: a density of about 30 kg/m³ to about 1200 kg/m³; and a weight average molecular weight of about 12,000 to about 50,000.

Embodiment 2: The foam of Embodiment 1, having an open cell content of 20% or less.

Embodiment 3: The foam of any of Embodiments 1-2, having an open cell content of 5% or less.

Embodiment 4: The foam of any of Embodiments 1-3, having a density of about 80 kg/m³to about 350 kg/m³.

Embodiment 5: The foam of any of Embodiments 1-4, having a weight average molecular weight of about 25,000 to about 50,000.

Embodiment 6: The foam of any of Embodiments 1-5, wherein the polycarbonate is derived from bisphenol-A.

Embodiment 7: The foam of any of Embodiments 1-6, wherein the polycarbonate is a branched polycarbonate.

Embodiment 8: The foam of any of Embodiments 1-6, wherein the polycarbonate is a linear polycarbonate.

Embodiment 9: An article made from the foam of any of Embodiments 1-8 or containing the foam of any of Embodiments 1-8.

Embodiment 10: A process for making an anisotropic polycarbonate foam, comprising: melting a polycarbonate in an extruder to obtain a molten formulation; injecting a blowing agent into the molten formulation; mixing the molten formulation to obtain a single phase mixture; and extruding the single phase mixture through a die to obtain the anisotropic polycarbonate foam.

Embodiment 11: The process of Embodiment 10, wherein the blowing agent is isobutane.

Embodiment 12: The process of any of Embodiments 10-11, wherein the die has a length of about 1 mm to about 2 mm, and has a diameter of about 3 mm to about 10 mm.

Embodiment 13: The process of any of Embodiments 10-12, wherein the molten formulation includes a nucleating agent.

Embodiment 14: The process of Embodiment 13, wherein the nucleating agent is talcum or fused silica.

Embodiment 15: The process of any of Embodiments 10-14, wherein the die is maintained at a die temperature of about 150° C. to about 200° C.

Embodiment 16: The process of any of Embodiments 10-15, wherein the pressure drop during extrusion is between 3 MPa and 50 MPa, and the pressure drop rate is between 0.01 GPa/sec and 100 GPa/sec.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. An anisotropic polycarbonate foam, having:
a density of about 30 kg/m3 to about 1200 kg/m3; and
a weight average molecular weight of about 12,000 to about 50,000.

2. The foam of claim 1, having an open cell content of 20% or less.

3. The foam of claim 1, having an open cell content of 5% or less.

4. The foam of claim 1, having a density of about 80 kg/m3 to about 350 kg/m3.

5. The foam of claim 1, having a weight average molecular weight of about 25,000 to about 50,000.

6. The foam of claim 1, wherein the polycarbonate is derived from bisphenol-A.

7. The foam of claim 1, wherein the polycarbonate is a branched polycarbonate.

8. The foam of claim 1, wherein the polycarbonate is a linear polycarbonate.

9. An article made from the foam of claim 1 or containing the foam of claim 1.

10. A process for making an anisotropic polycarbonate foam, comprising:
melting a polycarbonate in an extruder to obtain a molten formulation;
injecting a blowing agent into the molten formulation;
mixing the molten formulation to obtain a single phase mixture; and
extruding the single phase mixture through a die to obtain the anisotropic polycarbonate foam.

11. The process of claim 10, wherein the blowing agent is isobutane.

12. The process of claim 10, wherein the die has a length of about 1 mm to about 2 mm, and has a diameter of about 3 mm to about 10 mm.

13. The process of claim 10, wherein the molten formulation includes a nucleating agent.

14. The process of claim 13, wherein the nucleating agent is talcum or fused silica.

15. The process of claim 10, wherein the die is maintained at a die temperature of about 150° C. to about 200° C.

16. The process of claim 10, wherein the pressure drop during extrusion is between 3 MPa and 50 MPa, and the pressure drop rate is between 0.01 GPa/sec and 100 GPa/sec.
